(19) United States
(12) Patent Application Publication
(10) Pub. No.: US 2012/0110587 A1
(43) Pub. Date: May 3, 2012

(54) Methods and apparatuses for accumulating and distributing processing power

(75) Inventors: Nikolaos Georgis, San Diego, CA (US); Adrian Crisan, San Diego, CA (US); Milton M. Frazier, San Marcos, CA (US)

(73) Assignee: Sony Corporation, Tokyo (JP)

(21) Appl. No.: 12/926,149

(22) Filed: Oct. 28, 2010

(51) Int. Cl. G06F 9/46

(52) U.S. Cl. 718/104

(57) ABSTRACT

Calculating and distributing resources of at least one electronic device over a network.

### BACKGROUND OF THE INVENTION

1. Field of the Invention

The present invention relates generally a method or system for calculating and distributing resources of at least one electronic device over a network.

2. Description of the Related Art

Although group computing and collective rendering systems are currently in practice, their current employment is limited in a number of ways.

First, for example, the World Community Grid (WCG) gives personal computer owners the ability to donate their spare or idle personal computer into a contributory processing scheme, known as distributed computing, where their personal computer becomes part of an elaborate super-computer. Thus, the super-computer is not a central machine located in the rooms of a development or research lab, rather it is the combination of thousands upon thousands of computers that in the aggregate work as one super-computer processing a single task.

Unfortunately, however, the WCG only permits task initiation by the scientists who need to analyze data and run simulations. The user is simply a contributor and does not gain a benefit from connecting to an aggregate processing system. An appropriate method requesting computation of a task, storing data, or tracking donations by a user is absent from this system.

Further, the WCG requires a user to actively sign-up to contribute, while not offering users a mechanism for forming and creating their own groups.

Furthermore, because users are unable to from their own groups the WCG lacks any ability for a user to utilize contact folders, trusted online communities, social sites, gaming communities, blog memberships, etc. in forming their own groups within the system.

The present invention seeks to remedy these shortcomings through a comprehensive group computing method and system that can dynamically model, remodel, and allocate resources to multiple tasks, such as rendering images, complex algorithms, storage, etc. Hence, the present invention relates generally to this method or system for calculating and distributing resources of at least one electronic device over a network.

### SUMMARY OF THE INVENTION

The present invention relates to a method or system for calculating and distributing resources of at least one electronic device over a network.

The present invention can be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the present invention are more fully disclosed in the following specification, reference being had to the accompanying drawings, in which:

FIG. 1 is a flow chart illustrating a method for calculating and distributing resources.

FIG. 2 is a flow chart further illustrating the selection of resources.

FIG. 3 is a flow chart further illustrating the calculation of resources.

FIG. 4 is a flow chart further illustrating the accumulation of resources.

FIG. 5 is a flow chart further illustrating the monitoring of resources.

FIG. 6 is a flow chart further illustrating the receipt of a task and distribution of a task segment.

FIG. 7 is a flow chart further illustrating the receiving and compiling of a task segment.

FIG. 8 is a flow chart further illustrating the correction of a task segment.

FIGS. 9a-9f are flow charts illustrating alternative embodiments of the present invention.

FIG. 10a-10c are graphs illustrating CPU status over time.

FIG. 11 is a screenshot indicating a device's resource use.

FIG. 12 is a screenshot indicating the time to render a frame.

FIG. 13 is a block diagram illustrating a device for calculating and distributing resources.

FIG. 14 is a schematic of a system for calculating and distributing resources.

FIG. 15 is a schematic of a self-discoverable electronic device for calculating and distributing resources.

### DETAILED DESCRIPTION OF THE INVENTION

In the following description, for purposes of explanation, numerous details are set forth, such as flowcharts and system configurations, to provide an understanding of one or more embodiments of the present invention. However, it is and will be apparent to one skilled in the art that these specific details are not required to practice the present invention.

The present invention relates to selecting a group; calculating resources of at least one electronic device in the group; accumulating the resources of the at least one electronic device; monitoring the resources of the at least one electronic device; receiving a task and distributing a task segment to the resources of the at least one electronic device; receiving and compiling a completed task segment from the at least one electronic device; and correcting an incomplete task segment.

Group selection, in the above embodiment, generally comprises, first, having a range of electronic devices that are, through one medium or another, connected to a system where the selection is taking place, for example, all personal computers (PCs) on a local area network (LAN) or all gaming consoles connected through a game forum on a wide area network (WAN) for online multiplayer play. Thus, devices may be connected to a system through WAN and LAN connections using any connection medium available.

Second, an exclusion, inclusion, or other selection mechanism is used to choose at least one of the devices in the range. For example, many social networks already exist where users sign-in and communicate. Within those social networks friendships form, romances start, colleagues connect, family reunite, and those with similar interest are led to each other. Thus, within these social networks bonds form between users and because a user trusts a person by association they will trust their processing power as well. Under the selection mechanism, a user could select a set of users (and by extension their associated electronic device) based on the bonds formed within the social network.

Roughly, a system or a user would compile a set of users and carve multiple groups from the set of users. Then, the system would label those groups and, subsequently, label each user (and by extension their associated electronic device) within the group. For example, a set of users may be twitter followers, Facebook friends, a contact list, a group of bloggers, or website subscribers, and a subsets, such as recommended tweeters, college friends, work contacts, editors, or administrators, respectively, could be the carved or selected group.

After group selection, a label or hierarchy is assigned. Further, the label will designate a ‘trust’ level. For example, a system that connects to a LAN within a corporation could extract a company's employee list based on usernames. The system may then either specifically select individuals or use pre-designations, such as “the marketing department” or “department managers,” to select a group within the employee list. Further, for example, Facebook's sibling and family designations may be utilized to carve a group from a Facebook friends list.

When using pre-designations or any selection mechanism, a system must associate electronic devices with the individual machines. One example of electronic device association may be utilizing usernames, the last PC logged onto by the usernames, and associating the media access control addresses (MAC Address) relative to that PC. However, associating electronic devices with a selected member may be completed outside of selection.

Further, after the systems selects a group, such as “department managers,” the system may also designate the associated PCs as excluded from or included in resource sharing. Note that there may be selection overlap, such as a specific user and there associated device may have multiple designations.

Also and as will be described below, a task ma be distributed to different groups within a system, as some groups may or may not be more suitable for specific tasks or some groups may have exclusionary preferences. Thus, a more complex hierarchy may be needed.

The hierarchy could be one tier where a group is labeled “trusted” and the users or their machines are unspecified. A “trusted group” may be where the electronic devices in a group are assumed to by secure electronic devices for transmitting task segments. Similarly, a hierarchy may have two tiers, such as “trusted,” “non-trusted,” and unspecified. The tier hierarchy may increase exponentially based on the system need.

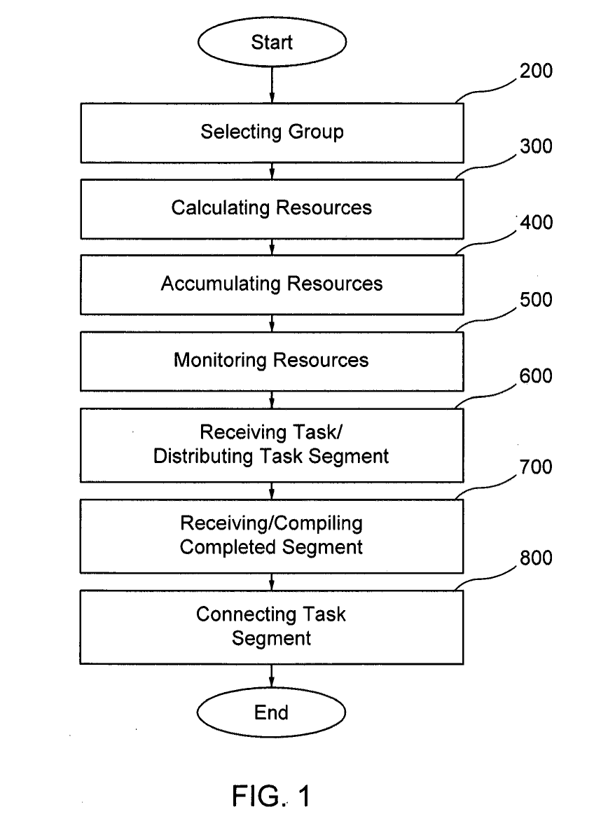

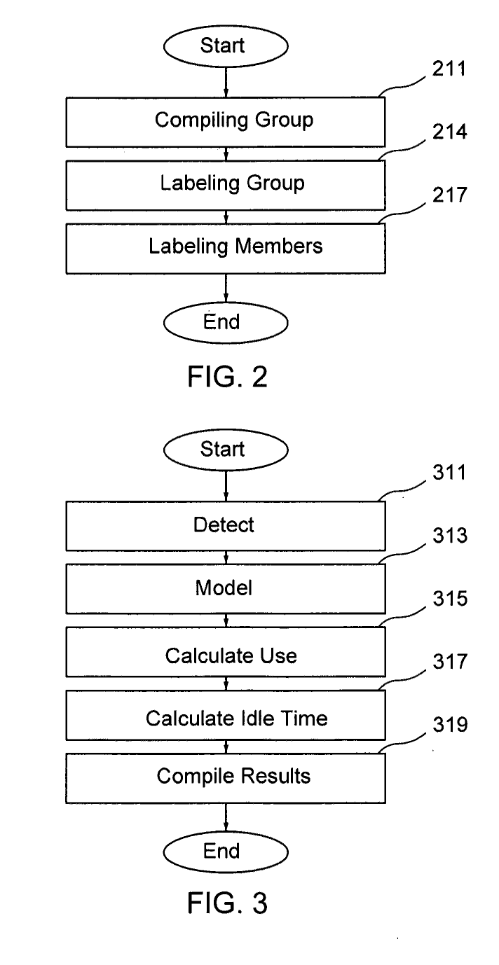

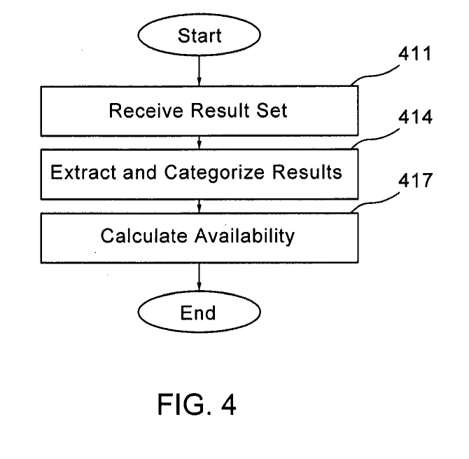

In addition, selection may be at the start of or at any time during the operation of the system. Selection may occur more than once, be repeated, altered, or adjusted. In FIG. 1, selecting a group Step 200 begins the process of sharing resources. In FIG. 2, compiling a set of groups for selection is carried out by first selecting one group from a user pool or set of groups Step 211. A user pool, as explained above, may be twitter followers, Facebook friends, a contact list, a group of bloggers, or website subscribers.

Next, the compiled group is labeled with a hierarchal designation Step 214, such as labeling one group as a “trusted group,” and then the members within the group are given individual designations Step 217, such as labeling each electronic device associated with a member in the trusted group as a trusted electronic device and further assigning a priority number to that device or the components within that device. Thus, the selecting and label steps in FIG. 2 may be a more complex hierarchy through prioritizing a system's groups and group members.

A system may automatically and dynamically select a group Step 200; however, a system is not limited to autonomous action, as a system or user may have prior knowledge of the availability or capabilities of a group and its specific members. Thus, further hierarchal structuring may be necessary. A system may also prompt or receive commands from a user or a third party system to perform a selecting. Further, the system may utilize a graphics user interface (GUI) to provide a user-friendly environment for selecting.

According to the above embodiment, after group selection Step 200, a system must calculate the resources Step 300 within the group. The initial calculation of resources is a first modeling mechanism and it provides the foundation for a latter dynamic modeling and optimization.

To calculate the resources within a group, as indicated in FIG. 3, a system detects Step 311 at least one electronic device within the selected group, models Step 313 the components and connections of the electronic device, calculates the use Step 315 of those components and connections, calculates the idle percentage Step 317 of those components and connections; and compiles a result set Step 319.

For example, detecting an electronic device may be effected by a system seeking selected group members through an echo request, such as ping, or, as indicated above, a MAC address look-up. Detection is not limited to these mechanisms and may be effected by any number or combination of detection mechanisms.

Further, once a device is detected, modeling begins and “traces” the nuts and bolts of an electronic device, regardless of whether an electronic device is a simple device, such as a processor and network interface; a complex device, such as a high-tech supercomputer with multiple processors and connections; or between those two extremes. Furthermore, an electronic device is not limited to a PC, rather an electronic device may be, for example, a mobile phone, a hand-held device, a personal computer, a digital clock, a digital watch, a global positioning system device, a scanner, a printer, a home theatre systems, a gaming machine, an electronic desk phone, a vehicle stereo, a vehicle's management computer, an handheld music player, a dishwasher, a microwave, a security system, a camera, a camcorder, or any other electronic device that has a processor and network interface. In addition, the network interface may be, for example, any communication technology that allows data transfer, such as an IP WAN/LAN network, WiFi network, Bluetooth, 3G wireless, 4G wireless, an IR interface, satellite, microwaves, etc.

For ease of comprehension, a laptop personal computer (laptop) will be utilized as an example of the at least one electronic device with a processor and a network interface device where the laptop's internal components of a read only memory (ROM), random access memory (RAM), graphics processor, central processing unit (CPU), network interface card, etc. will be the available resources. As indicated above and in FIG. 3, calculating resources requires detecting a device Step 311 then modeling the device resources Step 313.

Furthermore regarding modeling Step 313, the system identifies the specific components then collects the total processing capacity for each component. Thus, when the system calculates each component's current use Step 315 the system can also calculate the idle percentage of that component Step 317 by utilizing a component's total processing capacity. Similarly, when the system calculates a connection's use Step 315 the system can also calculate the available bandwidth of that connection Step 317 by utilizing the information collected when modeling Step 313 the components. Finally, the system must compile Step 319 these results into a set of results.

Moreover, calculation Step 300 is directed towards a single device of the plurality of selected devices; therefore, calculation must occur per device. And after each device has been calculated and since the system now has a plethora of separate device data, the system must process that data to ascertain the available resources of the system. Thus, the system accumulates the calculated resources for each of the plurality of separate electronic devices Step 400 by receiving the result sets Step 411 and categorizing the extracted resource data Step 414 from each result set. Then, the system calculates a total resource component availability.

Thus, with established groups and accumulated resources the system will constantly monitor, optimize, and re-model while waiting for a task request. In other words, after an initial model is complete (Steps 300 and 400) the system utilizes the completed model for statistical optimization.

For example, if a system detects two laptops, Laptop A and Laptop B, that are equal electronic devices with equal system connections, then the system may optimize a model for equal distribution. Further, if a user begins an activity, such as web browsing, on Laptop A, then clearly the available resources for laptop A will decrease. When this decrease is detected Step 517 the system will re-model and re-optimize the distributions.

In another example, when Laptop A, which contains a state-of-the-art processor and connects to the system via a 56k Modem, and Laptop B, which contains a mid-level processor that is relatively slower than the state-of-the-art processor and connects to the system via a 1 GIG NIC, connect to the system the system will recognize the bottlenecks per device and statistically optimize the model for distributing tasks. Thus, although the Laptop A processor is faster than Laptop B the network connections for both Laptops will contribute proportionally to the optimization algorithm.

In addition, monitoring and optimization occurs dynamically and continuously; however, their frequencies may be toggled or adjusted. Also, optimization is generally completed using statistical techniques, such as regression or standard deviation; however, other statistical methods may be used. Thus, the optimization algorithm may also be adjusted or toggled.

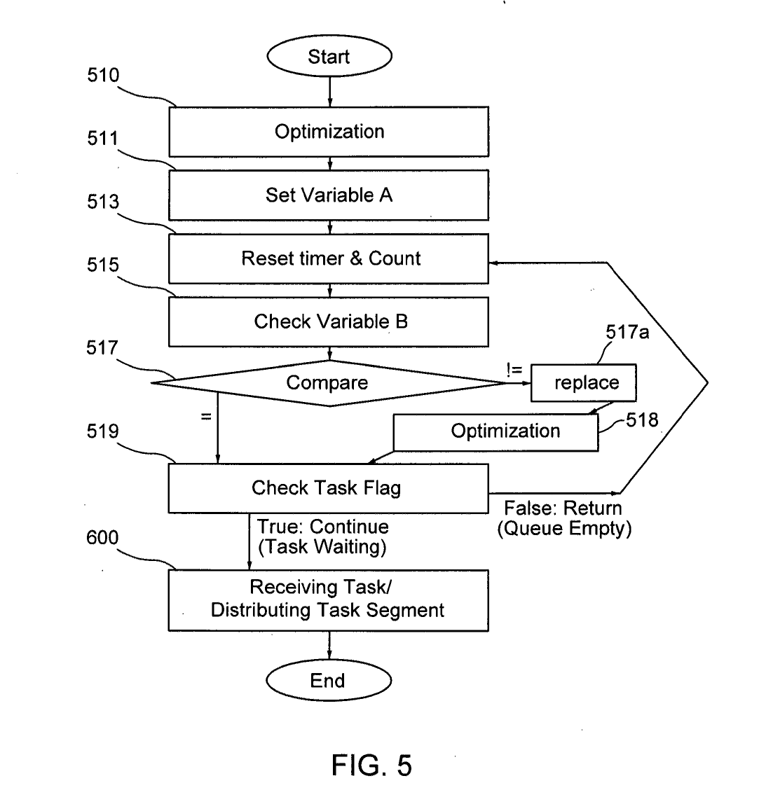

Now because, as indicated above, of the multiple variables per component, each component in a device must be monitored. Thus, monitoring Step 500 a device on a component scale is explained below and in reference to FIG. 5.

First, when monitoring the calculated resources of the plurality of separate electronic devices Step 500 an initial optimization Step 510 must occur. In the initial optimization Step 510, the system utilizes the model to calculate the optimal distribution for a most speedy task processing. After initial optimization Step 510, a first variable, which is assign to a specific component within an electronic devices, must be set Step 511 to a value equal to the idle time or to a value that indicates its resource availability. Next, a timer is set and started Step 513. The timer regulates how often the system checks a component's use. When the timer finishes, a component's current idle time is checked and set to a second variable Step 515. Then the first and second variables are compared Step 517.

When the first and second variables are equal the system checks a task flag Step 519. If the task flag is false, which means there are no tasks waiting to be distributed in the system, then the system resets the timer and counts again. However, if the task flag is true then the system moves to Receiving a Task/Distributing a Task Segment Step 600.

When the first and second variables are not equal the second variable value replaces the first variable's value and the system proceeds to re-optimization Step 518. After a re-optimization Step 518, the task flag is checked Step 519 and, as explained above, the monitoring continues or a task is processed Step 600.

Again, monitoring and optimization dynamically and constantly cycle so the task processing model is always active and updated, and, as such, when a task request is received the system will proactively know whether the task segments can be immediately distributed. In addition, although, in FIG. 1., monitoring Step 500 is before receiving and distributing Step 600, a system may re-optimized at anytime and during any step (i.e. Steps 200-800).

Further, it would be advantageous if the system re-optimized after the first distribution of task segments, as the component availability would change once the component received a task segment.

Monitoring and optimization Step 500, also, generate task segment predictability. Meaning, because a system constantly monitors and optimizes a shared computing platform the system will know an estimated time for a task segment's processing on a specific device.

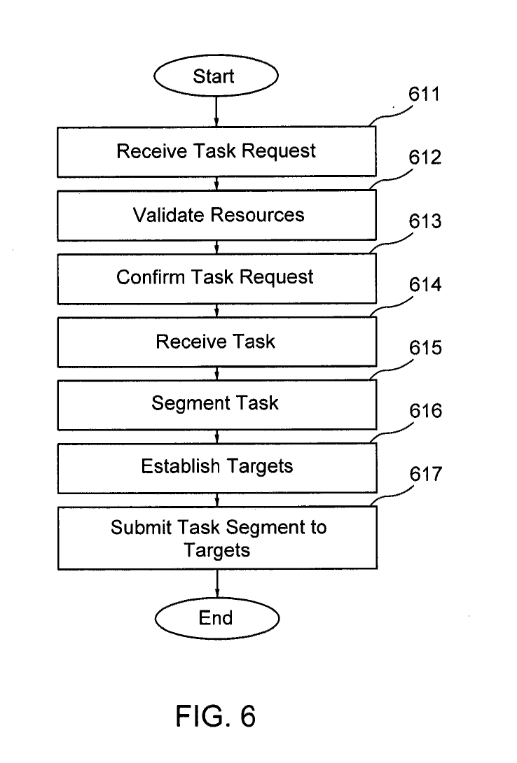

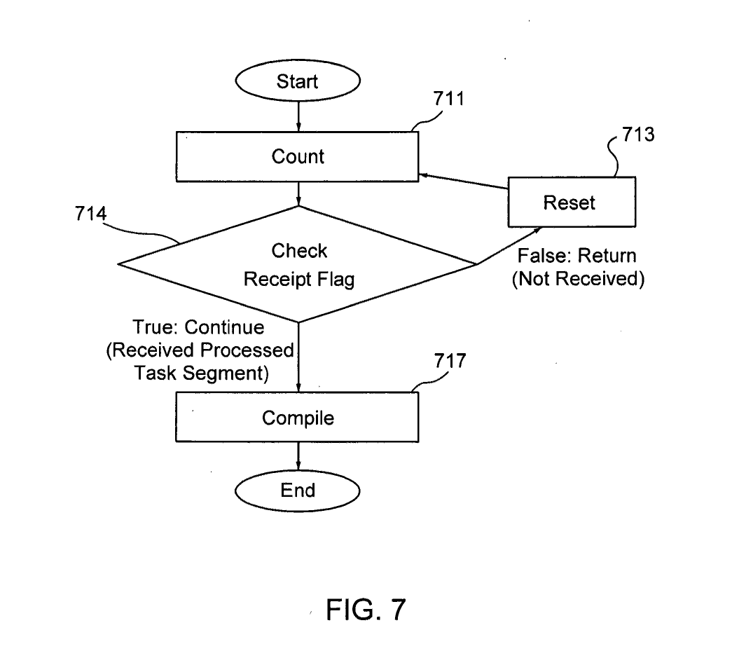

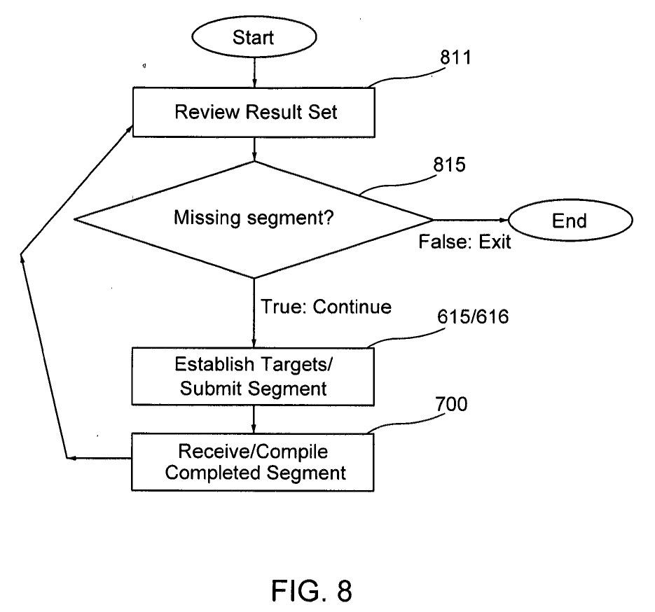

Regarding FIG. 6., for the system to receive a task and distribute a task segment Step 600 to the resources of at least one of the plurality of separate electronic devices it will generally, fist, have to handshake with the one electronic device. Thus, the system receives a task request from the electronic device Step 611, the system verifies a threshold percentage of available resources Step 612, such that if the system does not have available resources then the system will deny the request to process a task. Alternatively, the system may confirm the receipt of a task request but deny processing until further resources are available, or the system may add the task request to a task request queue. The queue may be a first in first out queue or last in first out stack. Also, the validation of resources may be based on the optimization and monitoring but could be based on another step, such as calculation Step 300.

After validation Step 612, the system confirms the request Step 613, which completes the handshake, and waits for the task itself. Once a task is received Step 614, the system segments that task into a task segments Step 615 and establishes a target connections and device resources for each segment Step 616 based on the optimized model. And because the model was already optimized the system can quickly submit Step 617 the task segments to their assign targets and estimate a completion time.

After receipt and distribution Step 600, a system waits to compile a returned processed task segment Step 700. The system uses a timer to count for the length of time equal to the estimated processing time for a segment Step 711. Then a system checks a task segment receipt flag Step 714. If the task segment receipt flag is true then the task segment has been received and the system proceeds to compile the received segment. If the task segment receipt flag is false then the task segment has not been received and the system resets Step 713 and counts again Step 711. The system may have an exit function (not shown) where a task segment is never received after a designated number of counting loops.

Receipt and Compile Step 700 must occur per task segment. Thus, in the aggregate, a system will wait for a set of process task segments i, check the relative task segment receipt flag RFi, and after either all the processed task segments were received or exit functions performed compile the sum Σ of processed task segments i where the segment receipt flag is true (RFi=1).

Further, if the system has missing or incomplete task segment it may have a correction function Step 800 for the incomplete task segment.

For instance, after compiling a task segment Step 700, a system will review a task segment and its relative flags for incomplete data, corrupted data, or missing data Step 800. The system may review the segments and check fags in any order or simultaneously. The system may review a task segment for any of the above error and if an error is found an error flag is set to true Step 811. Then a system checks an error flag Step 815. If the error flag is false then the system exits. If the error flag is true the system will resend the marked task segment for re-processing Step 615/616. After resubmission, the system must again wait to compile a processed task Step 700.

In addition to the above embodiment, layers of security and compression may be added to some or all transfers. For instance, encryption algorithms may be perform on the task segments and completed task segments. Further, the selection of groups may be based on secured connections, access levels, or a member's encryptions capabilities. Furthermore, the system may be selective on task segment distribution based on the task demands for security and resources available. These concerns may be addressed in any step in the above embodiment, for example, selecting, optimization and monitoring, calculating, etc.

Regarding the type of task for shared processing, a system may compute any task. However, the advantage of the above described system is its super-computing ability. Thus, complex image generation, large scale sampling computation, transcoding, etc. are examples of said task types.

For example, if an individual Laptop receives a task to transcode a movie, for instance a movie from a camcorder, so that the Laptop may upload the movie to a webpage, such as YouTube.com, the Laptop may take seven hours to transcode one frame of a movie. However, when the above system receives a task request to transcode a movie, the above system may transcode the movie in real time while uploading the movie to YouTube.com, such that for every Laptop within the system a frame may be rendered simultaneously. Further, if there are two Laptops then the total number of frames is divided by two. Furthermore, for X number of Laptops the total number of frames is divided by X Thus, if a system has only one Laptop that computes one frame per seven hours then a movie with a million frames would take years to transcode. However, if the system has half a million Laptops with similar capabilities then the movie could be transcoded in roughly fourteen hours plus other processing overhead.

Similarly, a high-resolution image may take 30 minutes for a LAPTOP to render. However, a because the image may be divided and distributed among the available processors such that each separate processor renders a different portion of the photograph (as in a pixel or a set of pixels) the system may reduce the rendering time by a factor of the number of electronic devices connected to the systems.

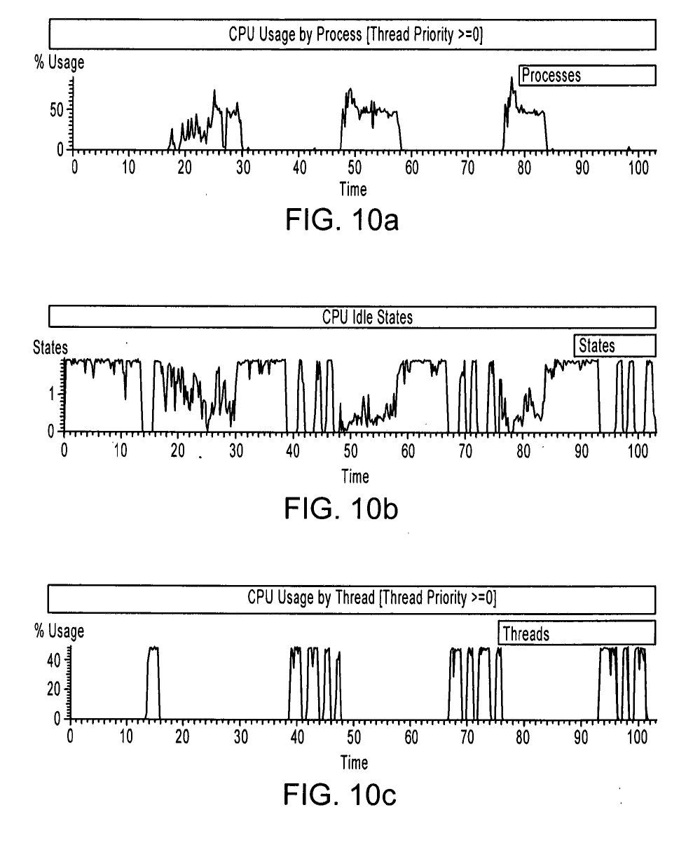

FIGS. 10a-10b, 11, and 12 are demonstrations of a system transcoding a movie 20 to 40 times faster than if one PC were to transcode the same movie independently.

FIG. 10a is the CPU usage by a PC over time; FIG. 10b is the CPU idle state over time; and FIG. 10C is the CPU usage by the systems over time. When comparing FIGS. 10a to 10b and 10c to 10b it is noted that the idle state is low when the CPU usage is active. Similarly, when comparing FIGS. 10a and 10c the CPU usage by the system is independent of the CPU usage by the PC. Also, when comparing these figures it is noted that after the CPU has been in an idle state for a specific period of time, i.e. 9 increments, the CPU usage by the system goes high; however when the CPU usage by the PC begins the CPU usage by the system immediately stops. These relationships are clearly demonstrated by the four sets of peaks in FIG. 10c and the three sets of peaks in FIG. 10a.

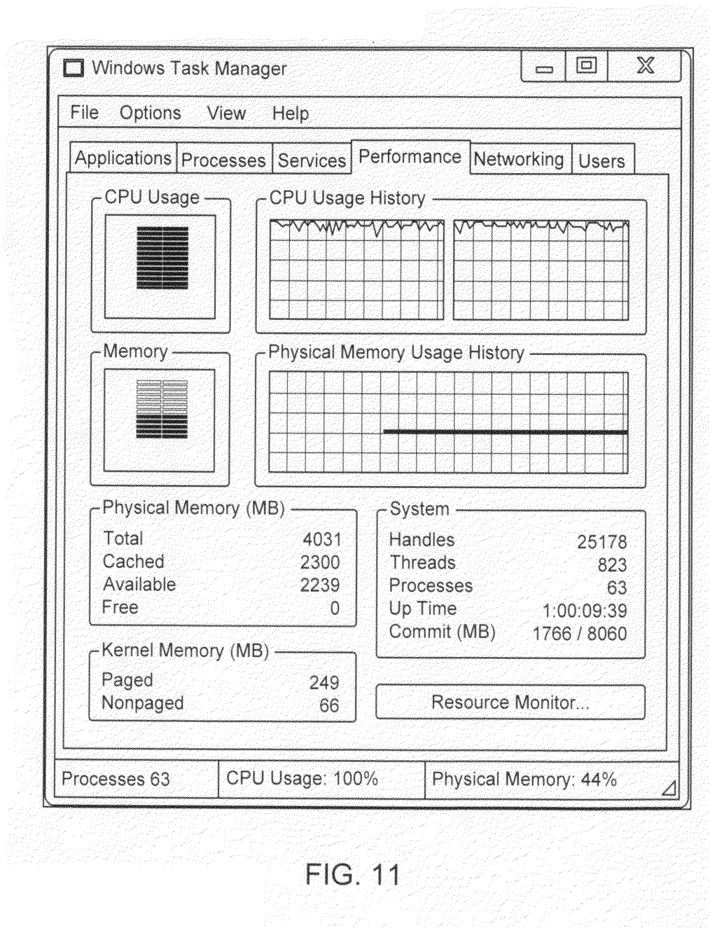

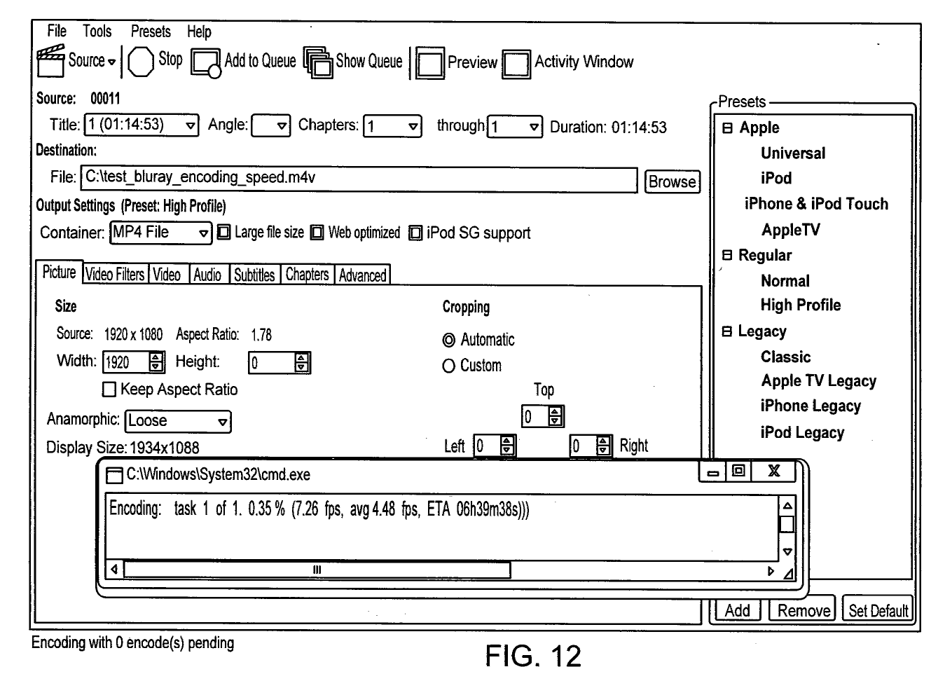

In FIG. 11, the PC's CPU usage is at 100%. If this usage is a PC usage then the CPU is not available as a resource for the system because the CPU is at full capacity.

However, the physical memory is only at 44%. Thus, the physical memory is 66% idle and is still an available resource for the system. The system may contain a threshold availability for a component where the system will never use a component if its current use is more than a designated amount, such as 50%. If the threshold is met then the system may label that component as an unavailable resource. Thus, if a 50% threshold for the components in FIG. 11 is used then the physical memory is available while the CPU is unavailable.

In FIG. 12, which is a screen shot, the PC in the system is estimating the remaining time to complete a distributed task of transcoding a frame (i.e. ETA 06 h39 m38 s). Further, if the frame was divided into segments, such as four quadrants, and this PC was designated to process only one of those segments, i.e. one quadrant, then the amount of time for this PC to finish transcoded would be divided by the number of segments, i.e. 6 h40 m/4=1 h40 m.

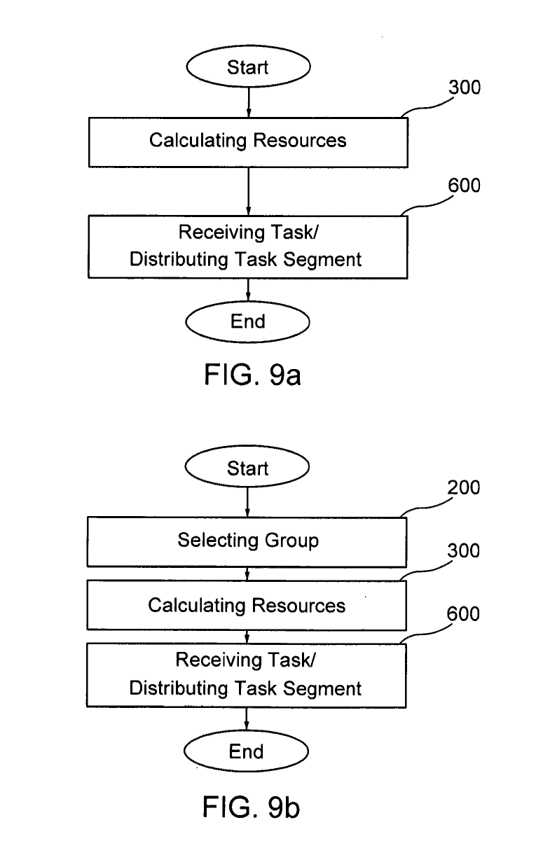

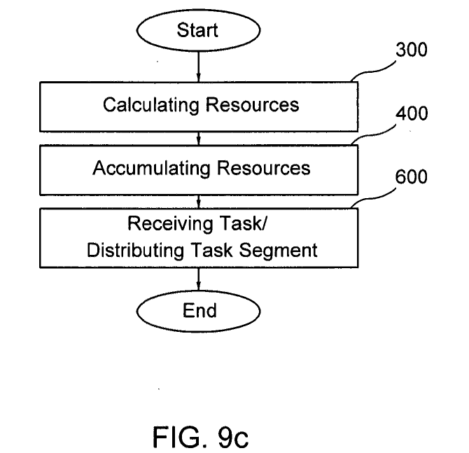

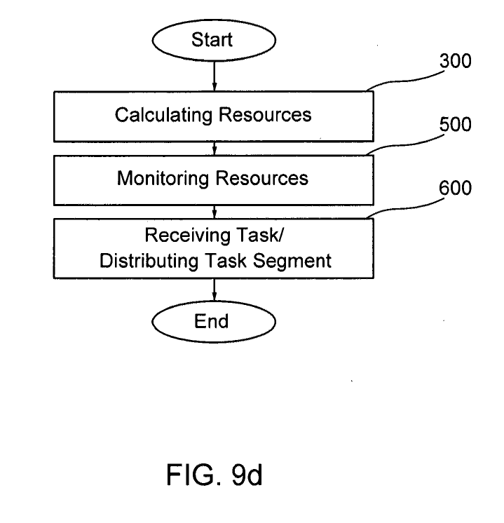

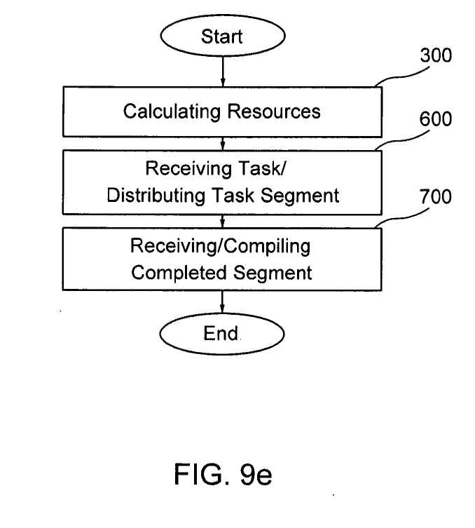

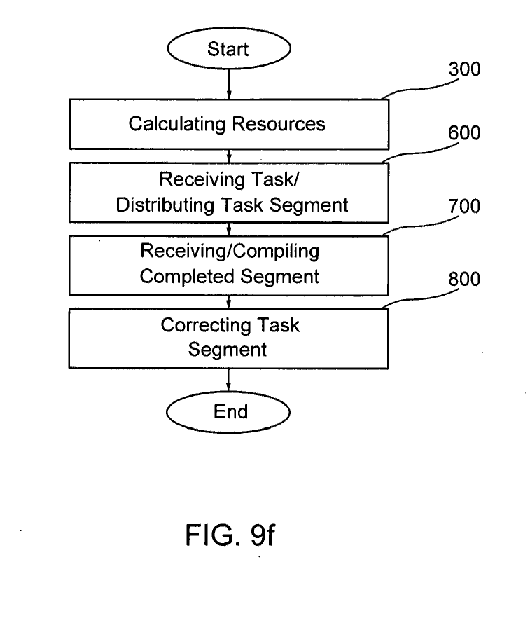

In alternative embodiments, the system may alternate the above described steps or perform the steps simultaneously. Thus, as described in FIGS. 9a through 9f, each step may be independently performed and multiple combinations of these steps may be grouped.

FIG. 9a illustrates an embodiment of the present invention where a system calculates resources, receives a task, and distributes task segments among those resources.

FIG. 9b illustrates an embodiment of the present invention where a system selects a group, calculates resources, receives a task, and distributes task segments among those resources.

FIG. 9c illustrates an embodiment of the present invention where a system calculates resources, accumulates resources, receives a task, and distributes task segments among those resources.

FIG. 9d illustrates an embodiment of the present invention where a system calculates resources, monitors resources, receives a task, and distributes task segments among those resources.

FIG. 9e illustrates an embodiment of the present invention where a system calculates resources, receives a task, distributes task segments among those resources, receives processed task segments, and compiles those received processed segments.

FIG. 9f illustrates an embodiment of the present invention where a system calculates resources, receives a task, distributes task segments among those resources, receives processed task segments, compiles those received processed segments, and corrects errors.

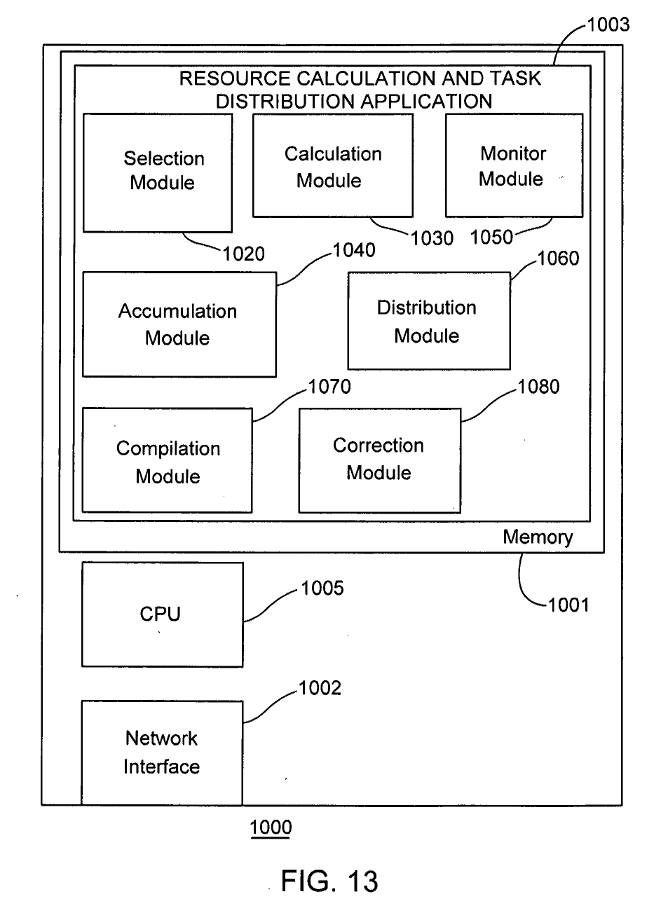

The systems may also be embodied in hardware, such as, in FIG. 13, an electronic device 1000 that has a network interface 1002 and a processor 1001. The processor further has a selection module 1020, a calculation module 1030, an accumulation module 1040, a monitor module 1050, a distribution module 1060, a compilation module 1070, and a correction module 1080. Alternatively, the hardware configuration may be configured with module setups similar to the embodiments of FIGS. 9a-9f.

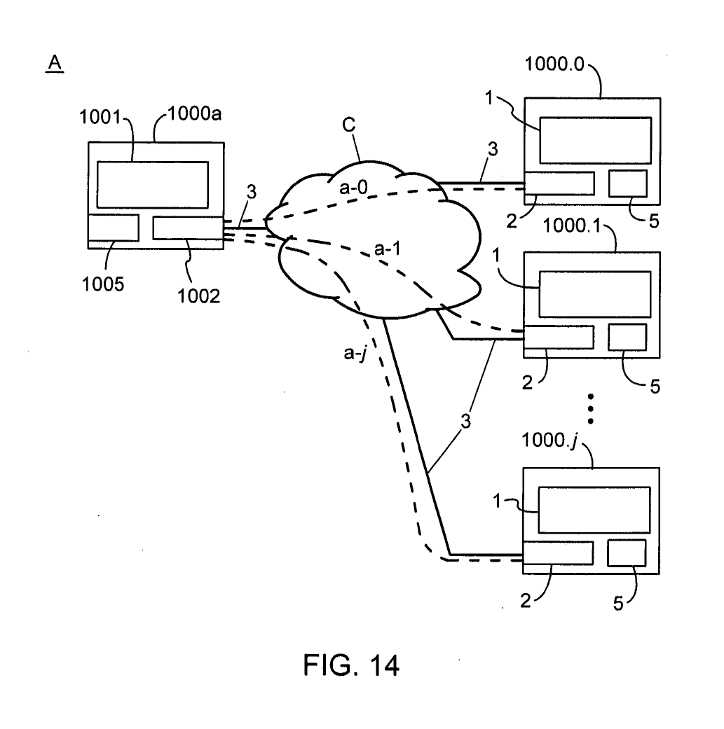

In addition, the system may be a server system that optimizes a client framework. In FIG. 14, a system A has an electronic device 1000a that has a network connection 1002 and a processor 1001. The processor 1001 may contain any of the combination of modules described above. The electronic device 1000a has physical connection 3 to a cloud C that permits virtual connections a-0, a-1, and a-j to electronic devices 1000.0, 1000.1, and 1000.j, respectively (where j is an integer representing the total number of electronic devices connected to the system). Each electronic device 1000.0 1000.j has a network interface 2 that has a physical connection 3 to the cloud C and resources 1.

For example, in the server embodiment a laptop, such as a Sony Vaio laptop, may be the server and the Vaio server 1000a may host a the Vaio distributed application and manage the clients 1000.0-1000.j. Further, the Vaio server 1000a may model the network by using a bandwidth estimator to minimize the time on network, by pinging for response times, and by modeling the available processors in a simulation to collect the statistics. Thus, a model is dynamically updated by a Vaio server 1000a in a Vaio exclusive cloud C.

Once the model is built, a Vaio server 1000a may distribute task segments across the cloud C based on the processing power demanded by a task and the connection speeds, security access, or even licensing and tracking described the model. Also, the clients 1000.0-1000.j may subscribe to multiple systems, networks, or groups.

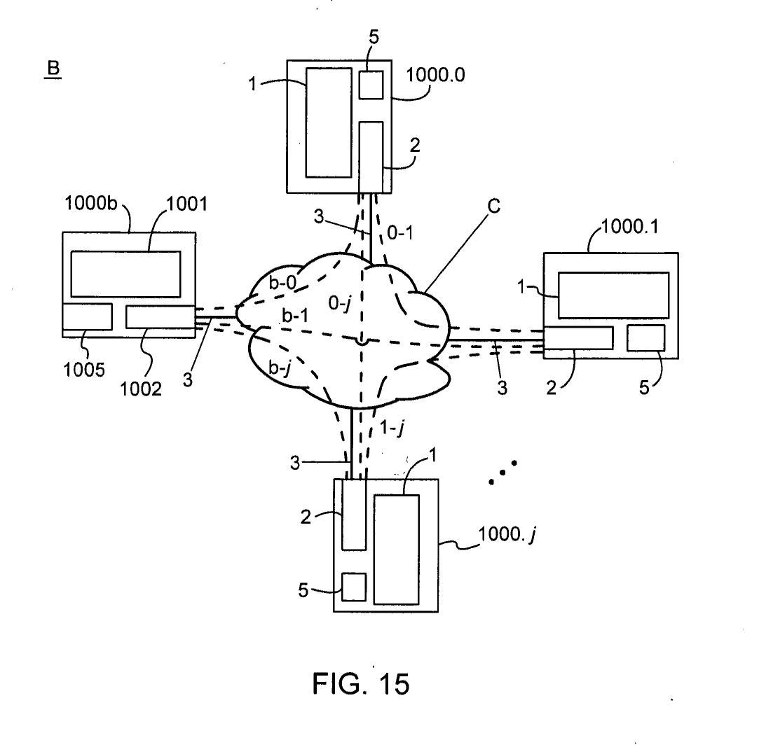

Alternatively, the system may be a self discovering client system. In FIG. 15, a system B has an electronic device 1000b that has a network connection 1002 and a processor 1001. Similarly to the server system, the processor 1001 of the electronic device 1000b may contain any of the combination of modules described above. The electronic device 1000b has physical connection 3 to a cloud C that permits virtual connections b-0, b-1, and b-j to electronic devices 1000.0, 1000.1, and 1000.j, respectively (where j is an integer representing the total number of electronic devices connected to the system). Each electronic device 1000.0-1000.j has a network interface 2 that has a physical connection 3 to the cloud C and resources 1. However, in the self-discovering client system, any electronic device in the system B may create and optimize a distribution model.

For example, a self-discovering application programming interface (API) on a Laptop client 1000b, such as a Sony Vaio laptop, may expose capabilities within the system B. The API would connect to other Sony Vaio clients 1000.1-1000.j in a handshake type communication, i.e. “Hey, are you there?”—“Hey, I am here, idle, and can do work.” Then the Sony Vaio client 1000b would propose a thread for the other Sony Vaio clients 1000.0-1000.j to run on their resources 3. Alternatively, the Sony Vaio client 1000b could request the other Sony Vaio clients 1000.0-1000.j to discover what resources are available on their neighbors, run a thread, and report when they are finished.

Also, in either above system, a CPU Multiplier, which is like a blade computer in an enterprise environment, may be added. CPU multipliers have no hard drive and comprise manly of processing power with a network interface. Thus, any module, for example the monitoring and optimization module, within the system could be supplemented by adding a multiplier.

Similarly, old and new electronic products may be added to the system. For example, an old computer would not necessarily need to be upgraded. It could be added to the system, have access to the aggregate processing power on the network, and be able to distribute, offload, or share a task. And the old computer does not have to be homogeneous with other electronic devices within the system. The old computer could be any different form factor, i.e. Linux, Linux embedded, Windows, etc., or contain any component brand, i.e. AMD or Intel. Further, other electronic devices not typically associated with shared computing, such as TVs, DVRs, etc., may be added. Thus, the present invention allow for a system to connect to devices within a home; describe the cumulative idle time; resource type, i.e. graphics processor, central processor, or any other type of processor know in the art; and distribute task segments to all available devices.

Marketing and selling resource may be another aspect of the system, as current grid computing is meant for enterprises and not meant for general consumers use. Therefore, the above system may allow electronic device owners to permit third-party systems to use their idle processing power. The third party may compensate the owners proportionally for the donated processing power. Thus, owners may be able to sell their resources to a third party, donate their resources to a charity, wholesale storage resources to a third party, or all of the above. Also, incentives may be offered, such as movie tickets or points to buy online movies or tax write-offs for charitable processor donation, to encourage electronic device owners to donate their processing power.

Thus embodiments of the present invention produce and provide a system for calculating resources and distributing segments. Although the present invention has been described in considerable detail with reference to certain embodiments, the invention may be variously embodied without departing from the spirit or scope of the invention. Therefore, the following claims should not be limited to the description of the embodiments contained herein in any way.

1. A method, comprising:
calculating resources of a plurality of separate electronic devices; and
receiving a task and distributing a task segment to the resources of at least one of the plurality of separate electronic devices.

2. The method of claim 1, further comprising:
selecting a group from the plurality of separate electronic devices.

3. The method of claim 2, wherein selecting the group from the plurality of separate electronic devices:
compiling a set of groups from the plurality of separate electronic devices by selecting members to associate with an unlabeled group from the set of groups;
labeling the unlabeled group as a trusted group; and
labeling each member in the trusted group as a trusted member.

4. The method of claim 1, wherein calculating the resources of the plurality of separate electronic devices comprises:
detecting at least a first device of the plurality of separate electronic devices;
modeling the first device and a first connection of the first device;
calculating a resource use of the first device and connection model;
calculating an idle percentage of the first device and connection model; and
compiling a set of results that comprises the first device model, the resource use, and the idle percentage.

5. The method of claim 1, further comprising:
accumulating the calculated resources of the plurality of separate electronic devices.

6. The method of claim 5, wherein accumulating the calculated resources of the plurality of separate electronic devices comprises:
receiving a set of results related the calculated resources of at least one of the plurality of separate electronic devices;
extracting and categorizing a resource component availability from the received set of results; and
calculating a total resource component availability.

7. The method of claim 1, further comprising:
monitoring the calculated resources of the plurality of separate electronic devices.

8. The method of claim 7, wherein monitoring the calculated resources of the plurality of separate electronic devices:
setting a first variable for the calculated resources of the plurality of separate electronic devices;
resetting and starting a timer;
checking a second variable when the timer has completed counting; and
comparing the first variable to the second variable,
wherein when the first variable equals the second variable check a task request flag,
wherein when the first variable does not equal the second variable replace the first variable with the second variable, reset second variable, and check the task request flag,
wherein when the task request flag is false then return to resetting and starting the timer.

9. The method of claim 1, wherein receiving the task and distributing the task segment to the resources of at least one of the plurality of separate electronic devices comprises:
receiving a task request;
validating a threshold percentage availability of resources of the calculated resources confirming the task request;
receiving the task;
segmenting the task into a task segment;
establishing a target connection and a target device resource; and
submitting the task segment to the target connection and the target device resource.

10. The method of claim 1, further comprising:
receiving and compiling a completed task segment from the at least one of the plurality of separate electronic devices.

11. The method of claim 10, wherein receiving and compiling the completed task segment from the at least one of the plurality of separate electronic devices comprises:
counting for a designated time;
checking a receipt flag when counting is complete,
wherein when the receipt flag is true the system compiles a received segment, and
wherein when the receipt flag is false the system recounts for the designated time and checks the receipt flag when the recounting is complete.

12. The method of claim 10, further comprising:
correcting an incomplete task segment.

13. The method of claim 12, wherein correcting the incomplete task segment comprises:
when the received completed task segment has an error,
re-distributing the task segment to the resources of at least one of the plurality of separate electronic devices.

14. A method comprising:
selecting a group from the plurality of separate electronic devices;
calculating resources of a plurality of separate electronic devices;
accumulating the calculated resources of the plurality of separate electronic devices;
monitoring the calculated resources of the plurality of separate electronic devices;
receiving a task and distributing a task segment to the resources of at least one of the plurality of separate electronic devices;
receiving and compiling a completed task segment from the at least one of the plurality of separate electronic devices; and
correcting an incomplete task segment.

15. A system, comprising:
a first electronic device configured to calculate resources of at least a second electronic device from a plurality of separate electronic devices; and
the first electronic device configured to distribute a task segment to the resources of at least the second electronic device.

16. A system, comprising:
a first electronic device configured to select at least a second electronic device from a plurality of separate electronic devices;
the first electronic device configured to calculate resources of the second electronic device;
the first electronic device configured to distribute a task segment to the resources of the second electronic device.

17. A system, comprising:
a first electronic device configured to calculate resources of at least a second electronic device from a plurality of separate electronic devices;
the first electronic device configured to monitor the resources of the second electronic device; and
the first electronic device configured to distribute a task segment to the resources of at least the second electronic device.

18. A system, comprising:
a first electronic device configured to select at least a second electronic device from a plurality of separate electronic devices;
the first electronic device configured to calculate resources of the second electronic device;
the first electronic device configured to accumulate the resources of the second electronic device;
the first electronic device configured to monitor the resources of the second electronic device;
the first electronic device configured to distribute a task segment to the resources of the second electronic device;
the first electronic device configured to receive and compile a completed task segment; and
the first electronic device configured to correct an incomplete task segment.

19. An electronic device, comprising:
a means for selecting resources;
a means for calculating resources;
a means for accumulating the resources of at least the second electronic device;
a means for monitoring the resources of at least the second electronic device;
a means for distributing a task segment to the resources of at least the second electronic device;
a means for receiving and compiling a completed task segment; and
a means for correcting an incomplete task segment.
